(19) United States
(12) Patent Application Publication
(10) Pub. No.: US 2013/0257898 A1
(43) Pub. Date: Oct. 3, 2013

(54) DIGITAL MEDIA MODIFICATION

(71) Applicants: Britt C. Ashcraft, Tomball, TX (US); Eric Chen, Houston, TX (US); Rudy Widiaman, Houston, TX (US)

(72) Inventors: Britt C. Ashcraft, Tomball, TX (US); Eric Chen, Houston, TX (US); Rudy Widiaman, Houston, TX (US)

(21) Appl. No.: 13/435,066

(22) Filed: Mar. 30, 2012

(51) Int. Cl. G09G 5/00; G06F 3/041

(52) U.S. Cl. 345/619

(57) ABSTRACT

Embodiments enable generation of a modification of digital media. The modification may be applied to one digital image of a plurality of associated digital images to be displayed via a client device. The modification may be identified in response to a scroll function. Once identified, the scroll function may stop and the digital image including the modification may be output.

### BACKGROUND

Client devices such as, but not limited to, notebook computers, slate devices, tablets, smart phones, mobile devices, and desktop computers enable users to consume digital media. Digital media may be presented to a user of a client device in multiple manners, for example, textual data or image data may be displayed on the client device in the form of a book, magazine, or article, among others. The data may be associated with one or more applications.

### BRIEF DESCRIPTION OF THE DRAWINGS

FIG. 1 illustrates a computing system in accordance with various embodiments of the present disclosure;

FIG. 2 illustrates a block diagram of a device in accordance with the present disclosure;

FIG. 3 illustrates another embodiment of a device in accordance with the present disclosure;

FIGS. 4-6 illustrate images of various user interfaces in accordance with the present disclosure; and

FIGS. 7-8 illustrates flow diagrams in accordance with various embodiments of the present disclosure.

### DETAILED DESCRIPTION OF DISCLOSED EMBODIMENTS

Client devices such as notebook computers, desktop computers, all-in-one computers, slates, tablets, electronic readers, mobile phones, and smart phones, among others, may enable consumption of digital media. Digital media is any data or information capable of being conveyed to a user. Examples of digital media may include text, graphics, video, or audio, among others. Text and graphics may be associated with a particular book, magazine, newspaper or other collection, and may be consumed or viewed within a particular application which executes on the client device.

A consumer experience associated with digital media may lag that of their analog (i.e., tangible or physical) counterparts. For example, a user reading paper edition of a book may be enabled to make annotations within a margin of the book, mark a starting and stopping place of their progress through the material, and note various points within the material to enable later reference, among others. The consumer experience associated with the digital media is limited in this sense.

In the present disclosure, methods, systems, and computer readable mediums, among others are disclosed, which enable a user to interact with digital media and implement functions that improve the consumer experience. The interactions with the digital media may take the form of modifications of the underlying digital media, such as, but not limited to, an inverted corner to designate a reference point. An inverted corner may resemble that of a folded corner of a physical or paper media (e.g., a dog ear).

The present disclosure will be described with reference to a client device having a touch sensitive display. Wherein a touch sensitive display enables a user to interface with the device and content via their hand and/or finger. It will be appreciated, however, that the teachings of the instant disclosure may be applied to various other client devices which utilize various peripheral devices including but not limited to keyboards, mice, and track-pads.

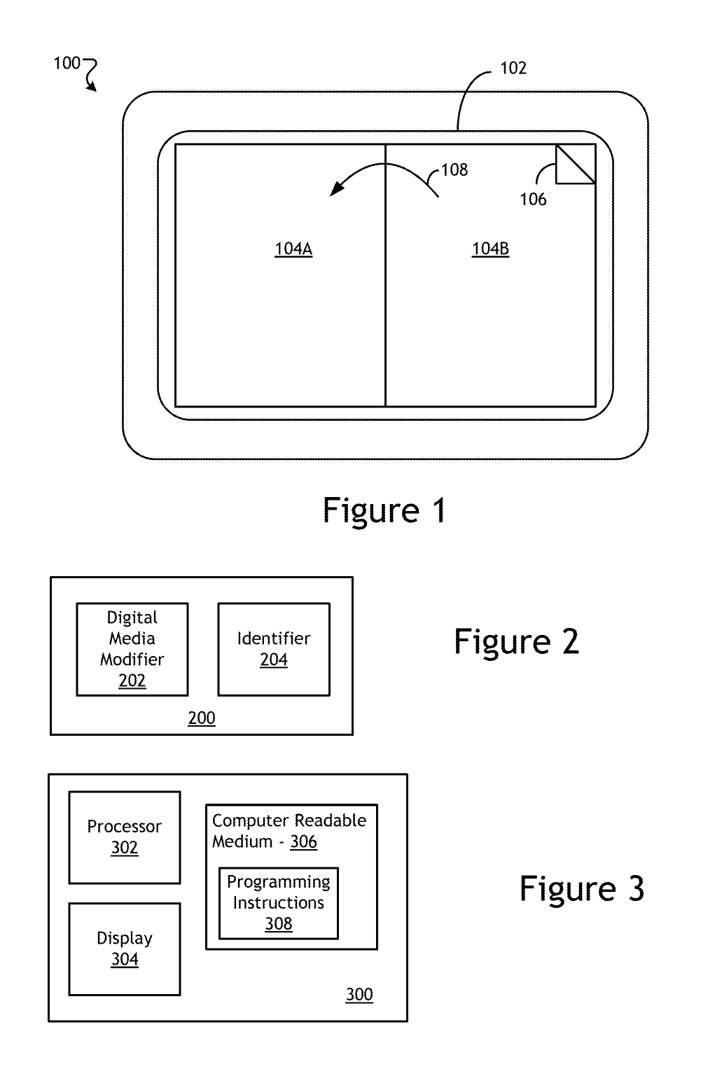

Referring to FIG. 1, a computing system is illustrated in accordance with an embodiment of the present invention. FIG. 1 illustrates a client device 100 including a display 102. The display 102 is illustrated outputting digital content in the form a book having a left side 104A and a right side 1048. A user of the device, may have previously marked the page 104B by inserting a modification of the underlying digital image, (e.g. a dog ear) 106. The modification may have been included within the digital media in a number of manners that will be discussed in more detail herein. Once included, the modification 106 may enable a user to quickly return to the modified page of digital media.

In one example, a scrolling function may be utilized to return to the modified page. A scrolling function, as used herein, may display a portion of the plurality of digital pages such that an appearance of quickly turning the pages of a paper book in accordance with arrow 108 is displayed. The scrolling function may be initiated via a gesture, such as swiping their finger across the application. In response to the gesture, the digital media may scroll to and automatically stop at the modified page of digital media.

In another example, the scroll function may execute in response to initiation of an application. Again, the scrolling function may appear to a user as scrolling through the preceding pages of a book. This may increase a consumer experience while reading a book or magazine and serve to blur the lines between an analog experience (i.e. reading the actual book) and the digital experience.

Referring to FIG. 2, a block diagram of a client device is illustrated in accordance with an embodiment of the present disclosure. The client device 200 includes a digital media modifier 202 and an identifier 204. The client device 200 may be a notebook computer, desktop computer, all-in-one computer, a slate, a tablet, an electronic reader (e-reader), a mobile phone, or a smart phone, among others.

The digital media modifier 202 may be implemented as in integrated circuit such as an application specific integrated circuit (ASIC). In other examples, the digital media modifier 202 may be implemented using logic. The digital media modifier 202 is to generate a modification and apply the modification to a digital image displayed on a display associated with the client device 200. In various examples, the digital image displayed via the apparatus 200 may be one of a plurality of associated digital images. For example, the image may be a page of a magazine or book including a plurality of associated pages. The modification, in various examples, may be adjustable. A modification, as used herein, describes a change or alteration of the page of digital media such that a user or client device, via various operations, may quickly return to the modified digital media.

Similar to the digital media modifier 202, the identifier 204 may be implemented as in integrated circuit such as an application specific integrated circuit (ASIC). In other examples, the identifier 204 may be implemented using logic. The digital media modifier 202 and the identifier 204, while discussed separately, may also be incorporated into a single component, for example, a controller. The identifier 204 is coupled to the digital media modifier 202 and is to identify the modification in response to a scroll function. A scroll function may be initiated automatically via the application, for example, upon initiation of the application or alternatively, in response to a gesture or prompt from a user, such as a swipe of a finger. Once identified, the identifier 204 may stop the scroll function to display the digital image and the modification.

The modifier 202 is to generate a modification. In one example, the modification is an inverted corner of the digital image. In various examples, the inverted corner may be adjustable such that a user may direct the inverted corner to a portion of the digital image. For example, a user may adjust the inverted corner to point at a paragraph where they had previously stopped reading or at a word, sentence, or image they wish to reference at a later time. In another example, the modifier 202, in addition to generating the modification, may include annotations within the modification. An annotation may be text or notes included by a user of the client device.

Referring to FIG. 3, another client device is illustrated in accordance with the present disclosure. The client device 300 includes a processor 302, a display 304, and a computer readable medium 306. The computer readable medium 306 may include programming instructions stored thereon, which when executed by the processor 302, enable the client device 300 to perform various operations. For example, the programming instructions 308 may enable the processor 302 to perform functions described previously with respect to the modifier and identifier.

In one example, the programming instructions 308 enable the client device 300 to detect a contact with a touch sensitive display of the client device at a first location on a page of digital media associated with an application. The first location, may be any location within the application, for example, the first location may correspond to a corner of the page displayed via the touch sensitive display. In response to detecting contact, the client device may then move the corner of the page of digital media to a second location in accordance with movement of the contact. As the corner is moved, it may be inverted to point toward the second location. For example, a user may touch the corner of the digital media and drag the corner to generate a modification. The modification may then point, via the inverted corner, to a specific location desired by the user. Upon a user desiring to return to the modification, the programming instructions 308, may enable the client device 300 to scroll to the modified page of digital media within a plurality of pages of digital media.

In various examples, client devices may enable customization of how digital media is viewed. For example, a client device may enable a user to change a font size of the digital media for ease of viewing and reading. Due to the static size of the display, the change in font may alter the number of digital pages within the application. In response to changes, the programming instructions, in various examples, may enable the client device to scroll to a modified page wherein the page is variable in size.

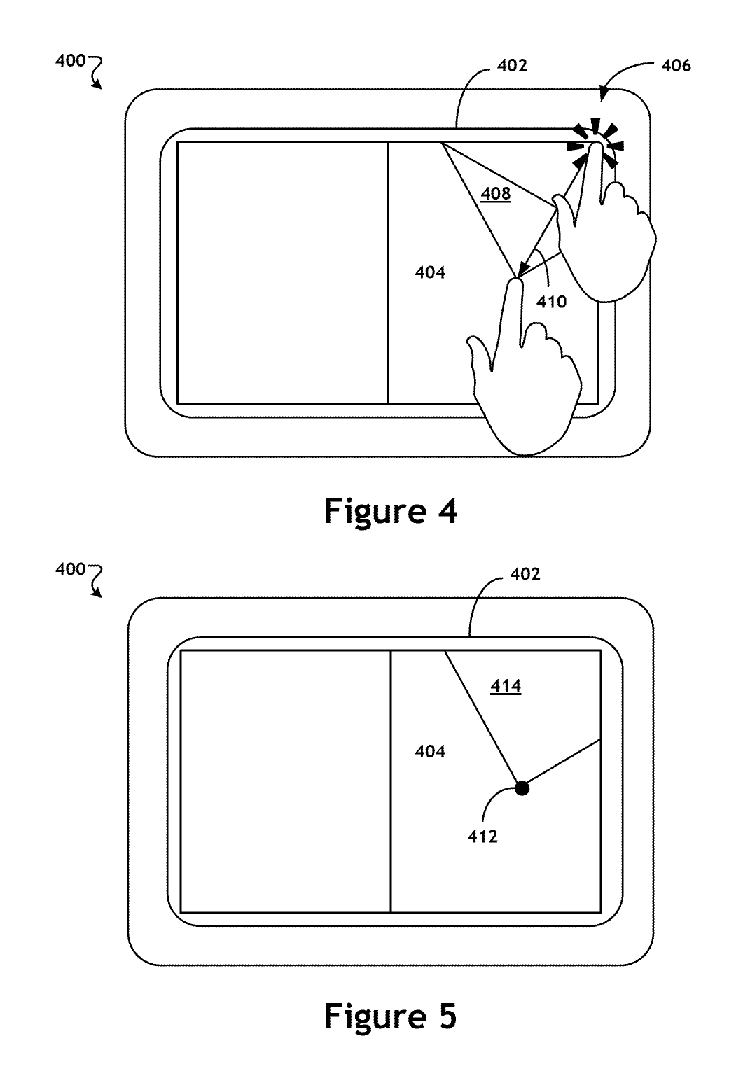

Referring to FIG. 4, an apparatus 400 is illustrated in accordance with an example of the present disclosure. The apparatus 400 includes a display 402 which is configured to display digital image 404. The apparatus 400, via a digital media modifier, for example, may generate a modification 408, for example, in response to a user gesture. In the illustrated example, the apparatus 400 may detect a contact with a touch sensitive display 402 of the client device at a first location on a page of digital media associated with an application, wherein the first location corresponds to a corner of the page displayed via the touch sensitive display. The client device 400 may move the corner of the page of digital media to a second location in accordance with movement of the contact, wherein the corner is inverted to form an inverted corner that points toward the second location 412, as seen in FIG. 5. In other examples, a modification may be generated by other gestures, for example a pinching gesture.

In FIG. 5, the second location 412 may be a user selected location that may pertain to a desired point of interest in which the user wishes to return. The movement from the first location to the second location may include the inversion of the corner such that the corner may now point to the second location. In one example, the second location may be a sentence, paragraph, or word last read by the user. In another example, the second location may be an image or article. In this manner a user may personalize a modification. Upon a re-initiation of the application associated with the plurality of pages, the intended page of digital media may be identified and displayed subsequent to a scrolling function.

In various examples, the modification or inverter corner may also include an annotation. An annotation is defined as text or image generated by a user. In the illustrated example, an annotation may be included within the area defined by the modification or inverted corner 414.

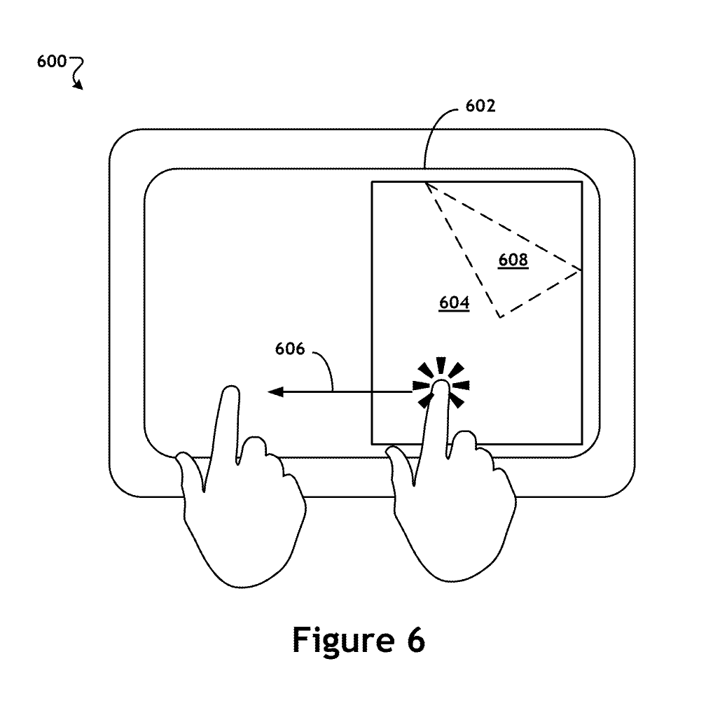

Once a modification has been generated, a user may wish to revisit the modification or bookmark. Referring to FIG. 6, an apparatus is illustrated in which the plurality of pages of the digital media 604 are present in a first state. The first state may be such that the digital media appears with a first page. The outline of a modification 608 is illustrated in dashed lines indicating that the modification is included therein. In various examples, the dashed lines may or may not be visible to a user in the initial state. Upon a gesture by the user. Indicated by arrow 606, a scrolling function may be initiated. The scrolling function may illustrate to the user that the pages of the digital media are being iteratively scrolled through at a rapid pace such that only a portion of each page of the plurality of pages is visible for a period of time. This may provide the illusion of scrolling through each page of the plurality of pages. The digital media may then stop scrolling once the modification 608 has been recognized.

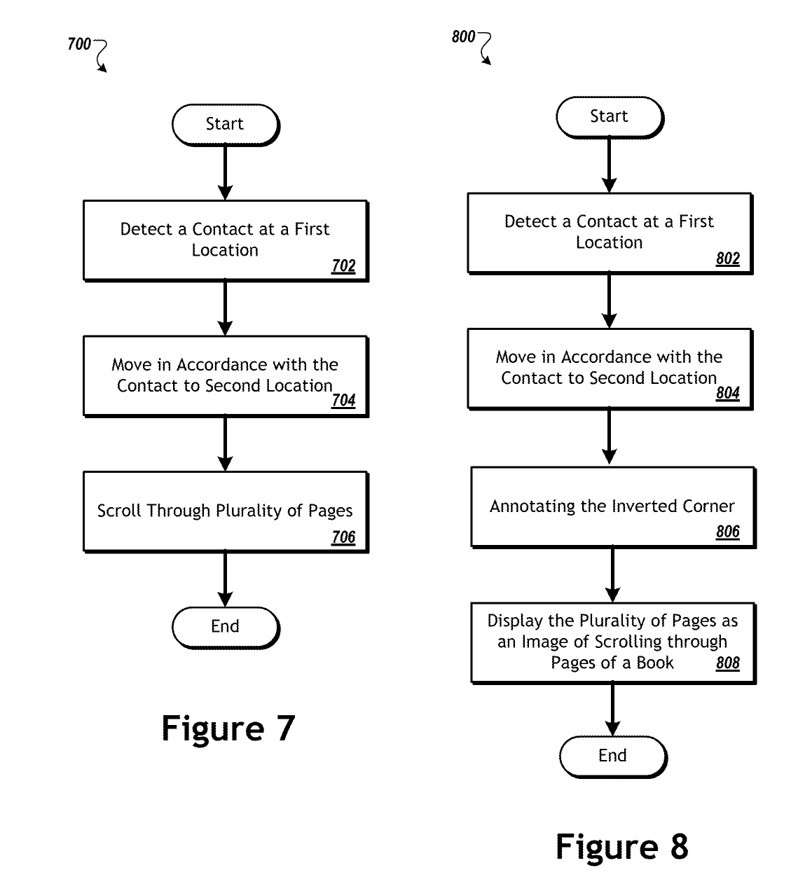

Referring to FIGS. 7 and 8 flow diagrams are illustrated in accordance with various examples. The flow diagrams may illustrate methods associated with the client devices as described with reference to the previous figures. While various elements are described with reference to the order that is illustrated in the figures, the disclosure is not so limited. Rather it is contemplated that various elements may be performed in different orders or simultaneously with other elements.

Referring to FIG. 7, the method may begin and progress to 702 where a client device may detect a contact at a first location. The first location in various examples may be a corner of a page of digital media being displayed by the client device. Alternatively, the first location may be another location within the page of digital media. At 704, the method may continue by moving the corner of the page of digital media to a second location. During movement to the second location, the movement may invert the corner of the page of digital media. This may enable the inverted corner to point to the second location such that a user viewing the inverted corner may determine the second location.

At 706, the method may scroll through the plurality of pages of digital media to the page of digital media that includes the inverted corner. The scrolling may occur in response to the initiation of the program once the inverted corner has been position, for example, upon the re-accessing of the digital media or the application. Alternatively, the scrolling function may be initiated based upon a prompt from a user. The method may then end.

Referring to FIG. 8, another flow diagram is illustrated. The flow diagram may begin and transition 802 where a client device may detect a contact at a first location. The first location in various examples may be a corner of a page of digital media being displayed by the client device. Alternatively, the first location may be another location within the page of digital media. At 804, the method may continue by moving the corner of the page of digital media to a second location. During movement to the second location, the movement may invert the corner of the page of digital media. This may enable the inverted corner to point to the second location such that a user viewing the inverted corner may determine the second location. Upon arrival at the second location, the method may continue to 806 where the client device may receive an annotation to be displayed via the inverted corner.

At 808, the method may continue and the client device may display the plurality of pages as an image of scrolling through the pages of a book. The scrolling function may be displayed for an amount of time correlated to an amount of preceding pages, or alternatively, may merely display scrolling pages for a preset amount of time. Upon arriving at a page of digital media including a modification, the scrolling function may stop. The method may then end.

Although certain embodiments have been illustrated and described herein, it will be appreciated by those of ordinary skill in the art that a wide variety of alternate and/or equivalent embodiments or implementations calculated to achieve the same purposes may be substituted for the embodiments shown and described without departing from the scope. Those with skill in the art will readily appreciate that embodiments may be implemented in a very wide variety of ways. This application is intended to cover any adaptations or variations of the embodiments discussed herein. Therefore, it is manifestly intended that embodiments be limited only by the claims and the equivalents thereof.

What is claimed is:

1. An apparatus, comprising:
a touch sensitive display to output a plurality of images of associated digital media;
a digital media modifier to generate a modification and apply the modification to an image of the plurality of images output via the touch sensitive display; and
an identifier to identify a gesture input via the touch sensitive display, and in response to the gesture, display a scroll function and subsequently the image of the plurality of images and the modification.

2. The apparatus of claim 1, wherein the modification is an inverted corner of the digital media.

3. The apparatus of claim 2, wherein the inverted corner of the modification points to a portion of the image of the plurality of images.

4. The apparatus of clam 2, wherein the inverted corner of the modification points to a word displayed within the image of the plurality of images.

5. The apparatus of claim 1, wherein the modification includes an annotation.

6. The apparatus of claim 1, wherein the scroll function is to display a portion the plurality of pages to generate an appearance of turning a plurality of pages of media.

7. The apparatus of claim 6, wherein the gesture comprises a swipe of a user's finger.

8. The apparatus of claim 1, wherein the digital media modifier is to generate the modification in response to a user gesture.

9. The apparatus of claim 8, wherein the user gesture is a pinch gesture.

10. A computer readable medium including a plurality of programming instructions that, if executed by a processor of a client device, cause the client device to:
detect a contact with a touch sensitive display at a first location on a page of digital media, wherein the first location corresponds to a corner of the page displayed via the touch sensitive display; and
move the corner of the page of digital media to a second location in accordance with movement of the contact, wherein the corner is inverted to form an inverted corner that points toward the second location.

11. The computer readable medium of claim 10, wherein the page of digital media is variable in size dependent upon a size of font displayed on the page of digital media.

12. The computer readable medium of claim 10, wherein the user determined location corresponds to a word displayed on the page of digital media.

13. The computer readable medium of claim 10, wherein the plurality of programming instructions, if executed by the processer of the client device, further cause the client device to:
display an annotation within a portion of the page of digital media, wherein the portion of the page of digital media includes the inverted corner.

14. The computer readable medium of claim 10, wherein the plurality of programming instructions, if executed by the processor of the client device, further cause the client device to:
display a portion of the plurality of pages of the digital media to generate an appearance of a scrolling function.

15. The computer readable medium of claim 10, wherein the plurality of programming instructions, if executed by the processor of the client device, further cause the client device to:
annotate the inverted corner with a received annotation.

16. The computer readable medium of claim 10, wherein the plurality of programming instructions, if executed by the processor of the client device, further cause the client device to:
output the page of digital media with the inverted corner in response to a scroll function.

17. The computer readable medium of claim 10, wherein the plurality of programming instructions, if executed by the process of the client device, further cause the client device to:
output the page of digital media with the modification in response to a gesture received via the touch sensitive display.

18. A method, comprising:
detecting a contact with a touch sensitive display at a first location, wherein the first location corresponds to a corner of a page of digital media;
moving the corner of the page of digital media to a second location in accordance with movement of the contact, wherein the movement inverts the corner of the page of digital media; and
scrolling through a plurality of pages of digital media to the page of digital media that includes the inverted corner.

19. The method of claim 18, further comprising:
receiving an annotation to be displayed via the inverted corner of the page of digital media.

20. The method of claim 18, wherein scrolling through the plurality of pages comprises displaying the plurality of pages of digital media as a plurality of pages of a book.
